(19) United States
(12) Patent Application Publication
(10) Pub. No.: US 2025/0243123 A1
(43) Pub. Date: Jul. 31, 2025

(54) Polycrystalline Silicon Nitride Fibers

(71) Applicant: Government of the United States as represented by the Secretary of the Air Force, Wright-Patterson AFB, OH (US)

(72) Inventors: Hyunjun Kim, Centerville, OH (US); Michael K. Cinibulk, Bellbrook, OH (US); Randall S. Hay, Beavercreek, OH (US); Lisa M. Rueschhoff, Beavercreek Township, OH (US); Connor Wyckoff, Springfield, OH (US); Kristan A. Keller, Springboro, OH (US)

(21) Appl. No.: 19/038,923

(22) Filed: Jan. 28, 2025

Related U.S. Application Data
(60) Provisional application No. 63/626,328, filed on Jan. 29, 2024.

(51) Int. Cl. C04B 35/622; C04B 35/626

(52) U.S. Cl. CPC C04B 35/62295; C04B 35/6261; C04B 2235/3225; C04B 2235/524; C04B 2235/6581; C04B 2235/764

(57) ABSTRACT

A process for creating polycrystalline silicon nitride fibers includes dispersing silicon nitride (Si3N4) powder to create dispersed silicon nitride powder. The dispersed silicon nitride powder is then classified to create classified fine silicon nitride powder. Likewise, a sintering aid is dispersed to create a dispersed sintering aid and then classified to create a classified sintering aid. A plasticizer, a binder, and the classified sintering aid are added to the classified fine silicon nitride powder to define a compound. The compound is mixed to create a mixed slurry, which is then dried to create a material. The material is extruded through a nozzle that is less than 40 μm (microns) in diameter to create a preform, which is then sintered to create the polycrystalline silicon nitride fibers

### CROSS-REFERENCE TO RELATED APPLICATION

The present application claims priority to U.S. Provisional Application Ser. No. 63/626,328 filed Jan. 29, 2024, the contents of which is hereby incorporated by reference in its entry.

### RIGHTS OF THE GOVERNMENT

The invention described herein may be manufactured and used by or for the Government of the United States for all governmental purposes without the payment of any royalty.

### BACKGROUND

Various aspects of the present invention relate generally to polycrystalline silicon nitride fibers and more specifically to producing polycrystalline silicon nitride fibers using extrusion.

Silicon nitride is a thermodynamically stable chemical compound: Si₃N₄. Silicon nitride is a high-melting-point solid that is relatively chemically inert, is very hard, and includes a high thermal stability with strong optical nonlinearities for all-optical applications. As such, silicon nitride is used in automotive applications (e.g., engine parts), as bearings, any application that requires a high-temperature melting point, metal cutting, etc.

### BRIEF SUMMARY

According to aspects of the present invention, a process for creating polycrystalline silicon nitride fibers includes dispersing silicon nitride (Si3N4) powder to create dispersed silicon nitride powder. The dispersed silicon nitride powder is then classified to create classified fine silicon nitride powder. Likewise, a sintering aid is dispersed to create a dispersed sintering aid and then classified to create a classified sintering aid. A plasticizer, a binder, and the classified sintering aid are added to the classified fine silicon nitride powder to define a compound. The compound is mixed to create a mixed slurry, which is then dried to create a material. The material is extruded through a nozzle that is less than 40 μm (microns) in diameter to create a preform, which is then sintered to create the polycrystalline silicon nitride fibers.

### BRIEF DESCRIPTION OF THE SEVERAL VIEWS OF THE DRAWINGS

FIG. 1 is a flow chart illustrating a process for creating polycrystalline silicon nitride fibers using a nozzle that is less than 40 μm;

FIG. 2 is a photograph from a scanning electron microscope (SEM) showing a preform of a silicon nitride fiber, according to various aspects of the present disclosure;

FIG. 3 is a photograph from an SEM showing the preform of FIG. 2 zoomed in ten times, according to various aspects of the present disclosure;

FIG. 4 is a photograph from an SEM showing a sintered silicon nitride fiber from a fifty-micron nozzle, according to various aspects of the present disclosure; and

FIG. 5 is a photograph from an SEM showing a cross section of the fiber of FIG. 4, according to various aspects of the present disclosure.

### DETAILED DESCRIPTION

Processes described herein are for creating polycrystalline silicon nitride fibers. Silicon nitride powder is dispersed and classified, and a sintering aid is dispersed and classified. The classified silicon nitride powder and classified sintering aid are combined with a plasticizer and a binder to create a slurry that is dried while being agitated to produce a dried slurry with a desired viscosity. The dried slurry is then extruded via a nozzle with a diameter of forty microns or less to create a preform of the silicon nitride fiber. The preform is then sintered to create the fiber.

Using the processes described herein will produce polycrystalline silicon nitride fibers with smaller diameters than previously thought could be created with silicon nitride. For example, existing carboxymethylcellulose fibers can be about fifteen microns in diameter, and using the processes described herein, a silicon nitride fiber of the same diameter may be produced. The sintered polycrystalline silicon nitride fibers produced herein also have an added advantage of not experiencing strength degradation associated with amorphous silicon nitride fibers, because the silicon nitride fibers produced herein are dense, are void-free, and do not experience crystallization which degrades strength at elevated temperatures.

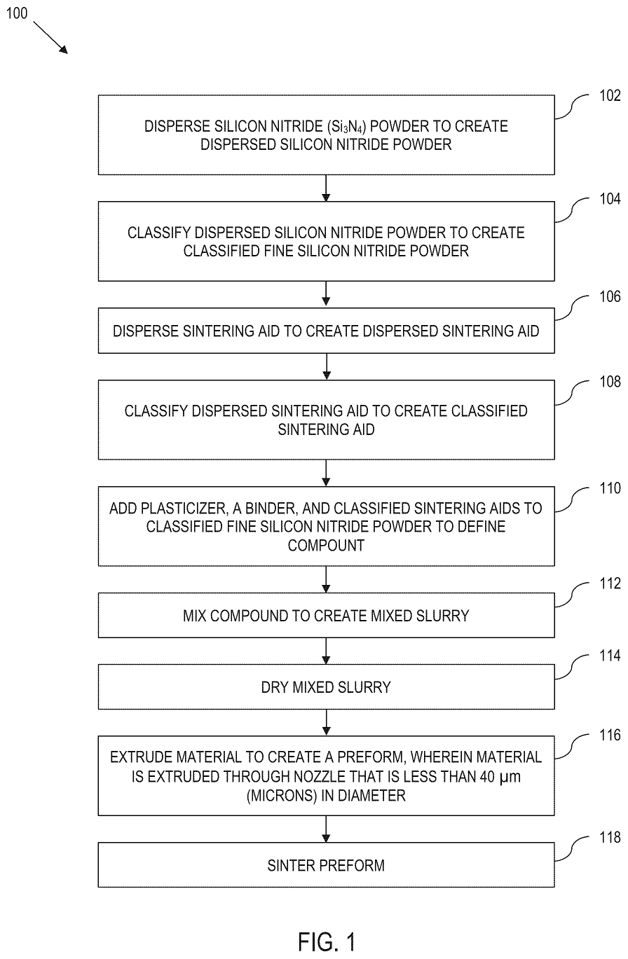

Turning now to FIG. 1, a process 100 for creating polycrystalline silicon nitride fibers is shown. At 102, silicon nitride (Si₃N₄) powder is dispersed to create a dispersed silicon nitride powder. For example, a solvent (e.g., water, organic solvents, etc.) may be added to the silicon nitride powder. The silicon nitride powder may be milled to disperse the silicon nitride powder. For example, ball milling, adhesion milling, attrition milling, etc., or combinations thereof may be used to disperse the silicon nitride powder. Moreover, any desired milling media may be used (e.g., alumina balls, silicon nitride balls, etc.).

At 104, the dispersed silicon nitride powder is classified to create classified fine silicon nitride powder. For example, classifying the dispersed silicon nitride powder can include using sedimentation (e.g., via a centrifuge, gravity, etc.) to separate the dispersed silicon nitride powder into a sediment and a supernatant. For example, if a centrifuge is used, the centrifuge can be run at five thousand revolutions per minute for about a minute.

Then, fine particles found in the supernatant are separated from a liquid of the supernatant as the fine silicon nitride powder, which have diameters less than a size of a nozzle used for extrusion later in the process. For example, if a forty-micron nozzle is used, then the fine silicon nitride powder should have diameters less than forty microns. As another example, if a twenty-micron nozzle is used, then the fine silicon nitride powder should have diameters less than twenty microns. Thus, an average particle size will be well below the size of the nozzle. For example an average particle size of the fine silicon nitride powder could be 600 nanometers (nm) for a forty-micron nozzle, 260 nm for a thirty-micron nozzle, 155 nm for a twenty-micron nozzle, etc.

An example of how to separate the fine particles from the supernatant includes using a centrifuge at thirteen-thousand revolutions per minute (13,000 rpm) for thirty minutes to classify the dispersed silicon nitride powder in a bottle. Then, clear water is decanted to obtain fine dispersed silicon nitride powder particles at a bottom of the bottle. This classifying helps to reduce an amount of time required for subsequent steps. However, other methods of classifying may be used including other speeds and times for the centrifuge, filtering (e.g., press filter, Buchner funnel, etc.), etc.

At 106, a sintering aid is dispersed to create a dispersed sintering aid. Sintering aids include metal oxide powders, metalloid oxide powders, etc. For example, yttrium aluminum garnet powder, aluminum oxide powder, dispersing yttrium oxide powder, silicon oxide powder, silicon dioxide powder, other rare earth metal oxides, etc., or combinations thereof may be used as a sintering aid. In several embodiments, the sintering aid is a single powder such as yttrium aluminum garnet powder. In various embodiments, more than one powder is used as sintering aids. In many embodiments that include more than one sintering aid, the sintering aids may be dispersed together or separately.

As with the dispersing of the silicon nitride powder (at 102), dispersing the sintering aid may include adding a solvent (e.g., water, organic solvents, etc.) to the sintering aid. The sintering aid may be milled to disperse the sintering aid. For example, ball milling, adhesion milling, attrition milling, etc., or combinations thereof may be used to disperse the silicon nitride powder. Moreover, any desired milling media may be used (e.g., alumina balls, silicon nitride balls, etc.). In various embodiments with more than one sintering aid, a first sintering aid is combined with a second sintering aid to create a combined sintering aid. A solvent is added to the combined sintering aid, which is then milled to create the dispersed sintering aid.

At 108, the dispersed sintering aid is classified to create a classified sintering aid. Any of the techniques discussed above in reference to classifying the silicon nitride may be used to classify the dispersed sintering aid. For example, the sintering aid may be classified using sedimentation via a centrifuge, gravity, etc. For example, if a centrifuge is used, the centrifuge can be run at five thousand revolutions per minute for about four to five minutes. Further, the classified sintering aid may be separated from a liquid of a supernatant, as discussed above in relation to classifying the silicon nitride powder. In other embodiments, the sintering aid may be the classified sintering aid slurry itself (without separating from the supernatant).

At 110, a plasticizer (e.g., glycerol), a binder (e.g., Methocel ceramic binder), and the classified sintering aid are added to the classified silicon nitride powder to define a compound. For example, the compound may include two parts classified sintering aid to at least eight parts classified fine silicon nitride powder—by weight. Further, the compound may comprise five parts plasticizer and binder together. Thus, in this example, the compound is at most five parts plasticizer and binder together, at most two parts classified sintering aid, and at least eight parts classified fine silicon nitride powder. Thus, there can be more than eight parts of classified fine silicon nitride powder than discussed above.

At 112, the compound is mixed to create a mixed slurry. Any method may be used to mix the compound, such as a planetary mixer in a vacuum or not in a vacuum. In some embodiments, the mixing is stopped once a desired viscosity for the slurry is met.

At 114, the mixed slurry is dried to create a material for extrusion. For example the mixed slurry may be dried by agitating the mixed slurry in a dry vacuum using an impeller, in a spinning container, etc. Drying with such agitation helps reduce clumps that may form during a drying process. Once a desired viscosity is reached for the material, the drying process stops. In embodiments that use water for a solvent or other purposes, the water is removed (e.g., vaporized) and the slurry is dried slowly-preferably with agitation as described above.

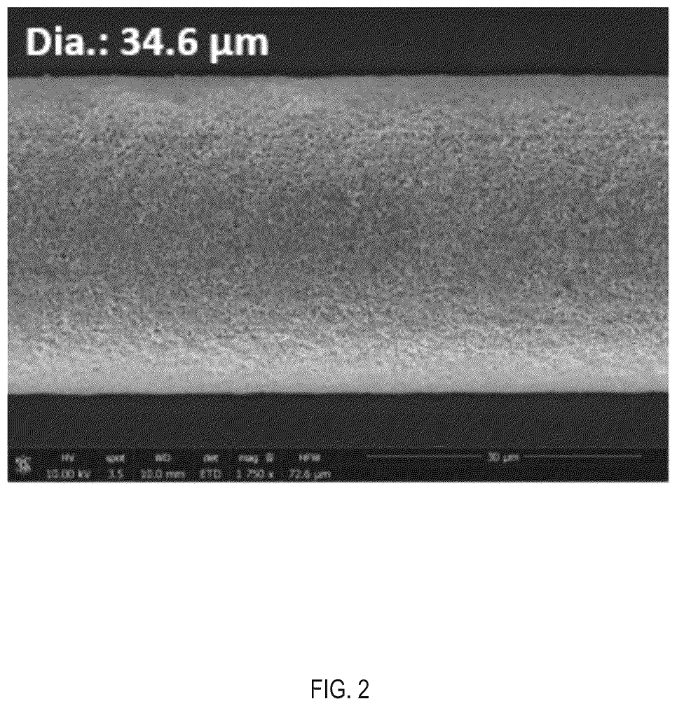

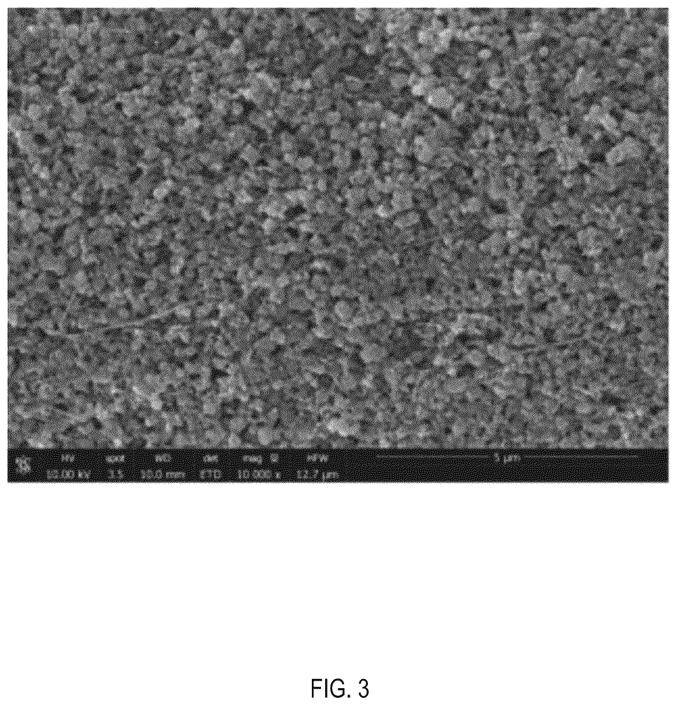

At 116, the material is extruded through a nozzle that is forty microns or less in diameter to create a preform. In some embodiments, the nozzle is forty microns. In various embodiments, the nozzle is thirty microns. In many embodiments, the nozzle is twenty microns. Recall that the size of the nozzle will influence the size of the classified particles (silicon nitride and sintering aid particles) as discussed above. FIG. 2 is a photograph of a preform created using a forty-micron nozzle by a scanning electron microscope. FIG. 3 is a photograph of the preform created of FIG. 2, zoomed in with a ten times resolution.

In some embodiments, the preform is extruded onto a turntable that turns as the preform is extruded. In such embodiments, a dryer (e.g., an infrared lamp) may dry the preform as it is extruded onto the turntable. Thus, when the preform hits the turntable, the preform is dry. A distance between the nozzle and the turntable is important, because a weight of the preform before it hits the table helps straighten out the preform, but if the distance is too great, the preform may break before sintering, below.

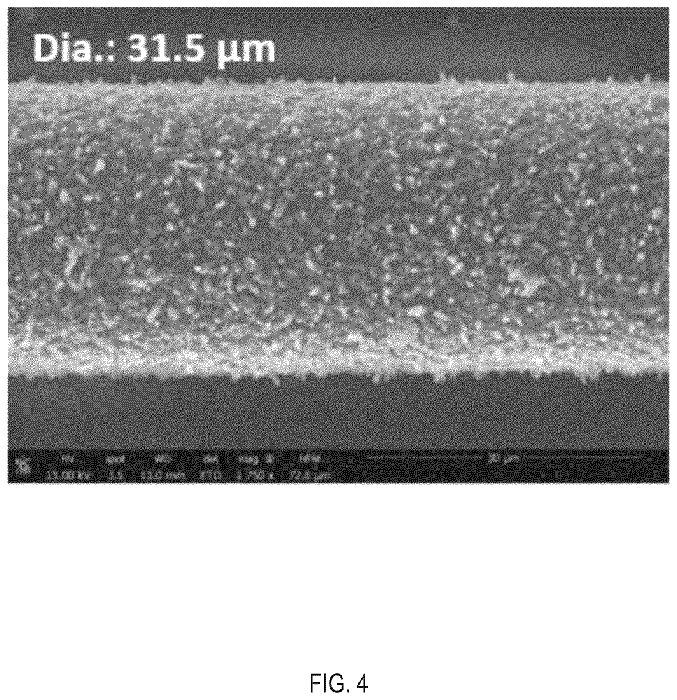

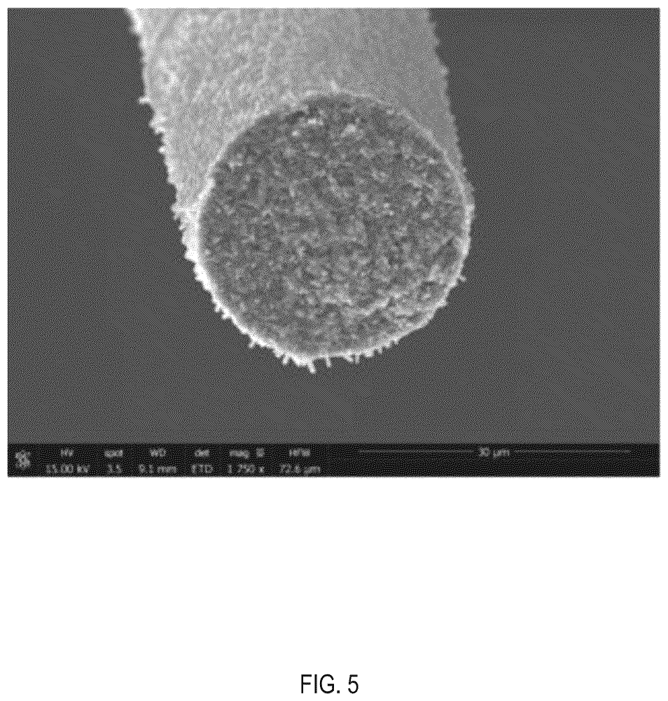

Referring back to FIG. 1, at 118, the preform is sintered to create the polycrystalline silicon nitride fiber. For example, the preform may be sintered in a nitrogen with a twenty degree Celsius per minute ramp rate and for one hour once the temperature reaches one-thousand-seven-hundred degrees Celsius. As another example, the sintering temperature may be between sixteen hundred degrees Celsius and one-thousand-seven-hundred degrees Celsius. Note that when the preform is sintered, there may be some shrinkage of the final silicon nitride fiber that results. This shrinkage during sintering is isotropic, so the sintering itself does not create any stresses. FIG. 4 is a photograph of a sintered polycrystalline silicon nitride fiber created using a fifty-micron nozzle by a scanning electron microscope. FIG. 5 is a photograph of the sintered polycrystalline silicon nitride fiber of FIG. 4 that is fractured to see a cross section.

In numerous embodiments, the polycrystalline silicon nitride fiber is checked to determine if a porosity of the polycrystalline silicon nitride fiber is outside a desired range. If so, then the fiber is processed further in a hot isostatic press.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Systems, devices and processes as described herein are disclosed herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A process for creating a polycrystalline silicon nitride fiber, the process comprising:
dispersing silicon nitride (Si₃N₄) powder to create dispersed silicon nitride powder;
classifying the dispersed silicon nitride powder to create classified fine silicon nitride powder;
dispersing a sintering aid to create a dispersed sintering aid;
classifying the dispersed sintering aid to create a classified sintering aid;
adding a plasticizer, a binder, and the classified sintering aid to the classified fine silicon nitride powder to define a compound;
mixing the compound to create a mixed slurry;
drying the mixed slurry to create a material for extrusion;
extruding the material to create a preform, wherein the material is extruded through a nozzle that is less than 40 μm (microns) in diameter; and
sintering the preform to create the polycrystalline silicon nitride fiber.

2. The process of claim 1, wherein dispersing silicon nitride (Si₃N₄) powder to create dispersed silicon nitride powder comprises:
adding solvent to the silicon nitride powder; and
milling the silicon nitride powder.

3. The process of claim 1, wherein classifying the dispersed silicon nitride powder to create classified fine silicon nitride powder comprises:
classifying the dispersed silicon nitride powder with sedimentation using select one of: gravity or a centrifuge.

4. The process of claim 1, wherein dispersing a sintering aid comprises dispersing metal oxide powder.

5. The process of claim 4, wherein dispersing metal oxide powder comprises dispersing yttrium aluminum garnet powder.

6. The process of claim 4, wherein dispersing metal oxide powder comprises dispersing aluminum oxide powder.

7. The process of claim 4, wherein dispersing metal oxide powder comprises dispersing yttrium oxide powder.

8. The process of claim 1, wherein dispersing a sintering aid comprises dispersing metalloid oxide powder.

9. The process of claim 1, wherein dispersing a sintering aid to create dispersed sintering aid comprises:
adding a solvent to the sintering aid; and
milling the sintering aid.

10. The process of claim 1, wherein dispersing a sintering aid to create dispersed sintering aid comprises:
combining a first sintering aid and a second sintering aid to create a combined sintering aid;
adding a solvent to the combined sintering aid; and
milling the combined sintering aid after the solvent has been added to create the dispersed sintering aid.

11. The process of claim 1, wherein classifying the dispersed sintering aid to create classified sintering aid comprises:
classifying the dispersed sintering aid with sedimentation using
select one of: gravity or a centrifuge.

12. The process of claim 1, wherein adding a plasticizer, a binder, and the classified sintering aid to the classified fine silicon nitride powder to define a compound comprises adding at most two parts of the classified sintering aid to at least eight parts of the classified fine silicon nitride powder.

13. The process of claim 12, wherein adding a plasticizer, a binder, and the classified sintering aid to the classified fine silicon nitride powder to define a compound further comprises adding at most five parts of the plasticizer and binder combined to at least eight parts of the classified fine silicon nitride powder, resulting in the compound being at most five parts plasticizer and binder, at most two parts classified sintering aid, and at least eight parts classified fine silicon nitride powder.

14. The process of claim 1, wherein drying the mixed slurry comprises drying the mixed slurry in a dry vacuum with agitation.

15. The process of claim 1, wherein extruding the material to create a preform comprises the material is extruded through a nozzle that is less than 30 μm in diameter.

16. The process of claim 1, wherein extruding the material to create a preform comprises the material is extruded through a nozzle that is less than 20 μm in diameter.

17. The process of claim 1 further comprising:
determining if a porosity of the polycrystalline silicon nitride fiber is outside a desired range; and
processing, if the porosity of the polycrystalline silicon nitride fiber is outside the desired range, further sintering the polycrystalline silicon nitride fiber in a hot isostatic press.

18. The process of claim 1, wherein classifying the dispersed silicon nitride powder to create classified fine silicon nitride powder comprises separating particles suspended in a supernatant from a liquid of the supernatant to create the classified fine silicon nitride powder.
